(19) United States
(12) Patent Application Publication
(10) Pub. No.: US 2026/0212322 A1
(43) Pub. Date: Jul. 23, 2026

(54) ADAPTING PRESENTATION CONTENT AUTOMATICALLY IN RESPONSE TO TIME CONSTRAINTS AND PROGRESS OF THE PRESENTATION

(71) Applicant: INTERNATIONAL BUSINESS MACHINES CORPORATION, Armonk, NY (US)

(72) Inventor: Xiao Song RAN, Knoxville, TN (US)

(21) Appl. No.: 19/026,835

(22) Filed: Jan. 17, 2025

(51) Int. Cl. G06Q 10/10; H04L 65/403

(52) U.S. Cl. CPC G06Q 10/10; H04L 65/403

(57) ABSTRACT

A method includes: determining a time allocated to remaining material in a digital presentation that is in progress exceeds a remaining presentation time for the digital presentation; and based on the determining the time allocated to remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

### BACKGROUND

Aspects of the present invention relate generally to computer-based presentation programs. A presentation program (also called presentation software) is software that permits a user to create and present a digital presentation using a computer. A common example of a digital presentation is a slide show that the user first creates using a presentation program (e.g., by adding content to individual slides in a user interface of the presentation program) and then presents using the presentation program (e.g., by displaying the slides via a computer display or projection system).

### SUMMARY

In a first aspect of the invention, there is a computer-implemented method including: determining a time allocated to remaining material in a digital presentation that is in progress exceeds a remaining presentation time for the digital presentation; and based on the determining the time allocated to remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

In another aspect of the invention, there is a computer program product including one or more computer-readable storage media and program instructions stored on the one or more computer-readable storage media to perform operations comprising: determining a time allocated to remaining material in a digital presentation that is in progress exceeds a remaining presentation time for the digital presentation; and based on the determining the time allocated to remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

In another aspect of the invention, there is a computer system including a processor set, one or more computer-readable storage media, and program instructions stored on the one or more computer-readable storage media to cause the processor set to perform operations comprising: determining a time allocated to remaining material in a digital presentation that is in progress exceeds a remaining presentation time for the digital presentation; and based on the determining the time allocated to remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment in accordance with aspects of the present invention.

FIG. 4 shows an exemplary workflow diagram that illustrates aspects of the present invention.

FIG. 5 shows a flowchart of an exemplary method in accordance with aspects of the present invention.

### DETAILED DESCRIPTION

Aspects of the present invention relate generally to computer-based presentation programs and, more particularly, to adapting digital presentation content automatically in response to time constraints and the progress of the presentation. Effective time control is important during the delivery of a presentation, particularly in professional or academic settings. Presenters must ensure they adhere to the designated time frame while effectively communicating their message and covering all essential points. Failing to manage time properly can result in several negative consequences, such as:
Incomplete Delivery: If the presenter runs out of time before covering all the intended content, the presentation may feel incomplete. Important information or key messages may be left out, leading to a lack of clarity or understanding for the audience.
Missed Key Points: Poor time management can lead to the omission of crucial points or supporting details. This can weaken the overall impact of the presentation and hinder the audience's comprehensive understanding of the topic.
Audience Disengagement: Exceeding the allocated time can cause audience disengagement and a loss of interest. Prolonged periods of listening without breaks or surpassing the audience's attention span may result in decreased focus and reduced receptiveness to the presented information.
Lack of Q&A (Question and Answer) or Discussion Time: Time control issues can result in insufficient time for audience questions, feedback, or interactive discussions. This limits engagement opportunities and prevents the presenter from addressing queries or concerns the audience may have.
Negative Perception: Presenters who consistently struggle with time management may be perceived as disorganized or unprepared. This can undermine their credibility and diminish the overall effectiveness of the presentation.

Implementations address and help avoid these problems by integrating a novel time-conscious presentation mode within presentation software, utilizing time estimation, priority ranking, and optional markers established by presenters for individual slides during the preparation phase. In accordance with aspects of the invention, this mode incorporates automatic time tracking and adjustment, automatic slide prioritization, uninterrupted presentation flow, and versatile implementation choices. Embodiments incorporate the following features to provide various improvements in the technical field of computer-based presentation programs:
Time Estimation and Optional Slide Marking: In embodiments, during the presentation document preparation phase, the presenter can provide a rough time estimation for each slide. Additionally, the presenter may mark certain slides as optional and assign a priority rating to each slide. This allows the presenter to indicate the importance and flexibility of specific slides in relation to time constraints.
Time Limit Setting: In embodiments, before activating the presentation mode for the actual delivery, the presenter sets a time limit for the entire presentation. This provides a clear target for the overall duration.
Time Checking and Automatic Adaptation: In embodiments, once the presentation mode starts, the presentation software employs a time checker to track the progress against the overall timeframe. As the presentation unfolds, the software estimates whether the remaining time will be insufficient to cover all slides adequately.
Automatic Slide Selection: In embodiments, in response to time constraints, the software internally selects and marks optional slides to be skipped in order to accommodate the available time. The selection process may be based on the priority ranking assigned by the presenter. Less important slides may be chosen to be skipped over those ranked with higher priority. Among the optional slides with the same priority ranking, the estimated time required for each slide and their position in the presentation may also be considered.
Seamless Presentation Flow: In embodiments, as the presenter proceeds with their delivery, the presentation software automatically skips the marked-skip slides as if they do not exist. This ensures a smoother flow for the presenter, and the audience remains unaware that certain content has been skipped. The presentation continues without interruptions that would be noticed if performed manually.
Implementation Options: In embodiments, the automatic content adaptation can be implemented either as software running on the local computer or hosted on a server, providing flexibility based on the presenter's preference and available resources.

Implementations of the invention provide an improvement in the technical field of computer-based presentation programs by providing one or more of the following advantages over existing techniques in the field:
Improved Adaptability: Embodiments of the present invention provide a dynamic and adaptive approach to time control during presentations by automatically selecting and skipping slides based on their priority and estimated time, ensuring that the essential content is covered within the given timeframe.
Seamless Transition: By automatically skipping optional slides in accordance with embodiments of the present invention, the presenter can maintain a smoother flow without the need for manual adjustments. This enhances the overall presentation experience and reduces the risk of disruptions caused by time constraints.
Flexibility for Presenters: By utilizing embodiments of the present invention, presenters have the ability to assign priorities to slides and indicate their flexibility in advance. This allows for a customized approach based on the importance and time sensitivity of each slide.
Efficient Time Management: Embodiments of the present invention optimize time management by ensuring that the presentation stays within the allotted timeframe without compromising the quality or impact of the core content.
Reduced Presenter Stress: With the automatic adaptation of optional slides in accordance with embodiments of the present invention, presenters can focus more on delivering the essential message rather than worrying about time constraints. This alleviates stress and enables a more confident and engaging presentation.

By incorporating these features into presentation software, embodiments provide an advanced and efficient approach to time control during presentations, enhancing the presenter's delivery and ensuring a seamless experience for the audience. In this manner, implementations provide an improvement in the technical field of computer-based presentation programs.

Implementations of the invention are necessarily rooted in computer technology. For example, the steps of saving data in a digital presentation document in a presentation program, and the presentation program automatically and dynamically adapting content in the digital presentation while the digital presentation is being displayed, are inherently computer based. Implementations embed metadata in a digital presentation document when the user creates the digital presentation document using a presentation program. Embedding metadata in a digital presentation document cannot be performed mentally or with pen and paper. Implementations also automatically and dynamically adapt content in the digital presentation while the digital presentation is being displayed, which can only be done by the presentation program and cannot be performed mentally or with pen and paper.

It should be understood that, to the extent implementations of the invention collect, store, or employ personal information provided by, or obtained from, individuals (for example, time control configuration data) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

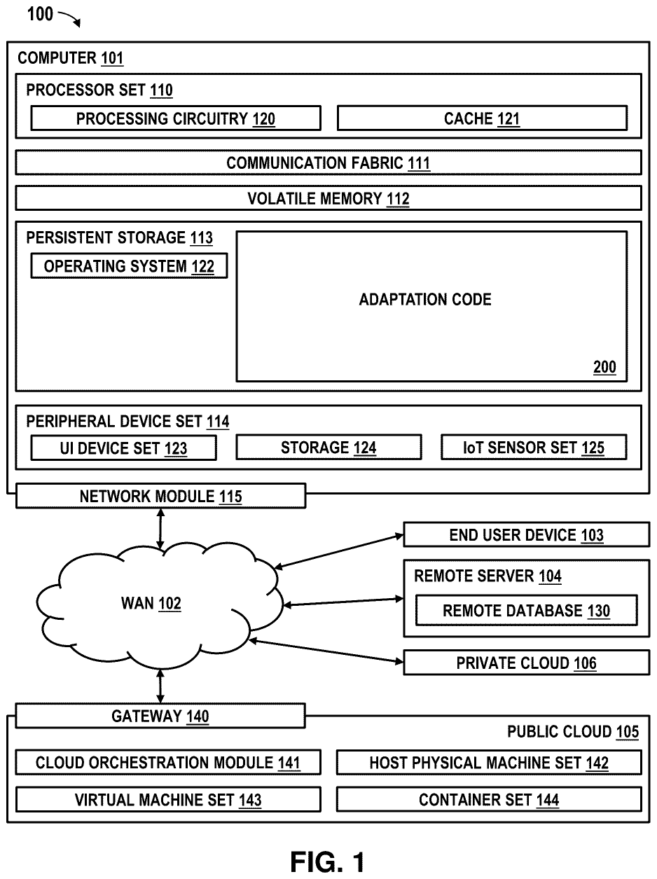

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

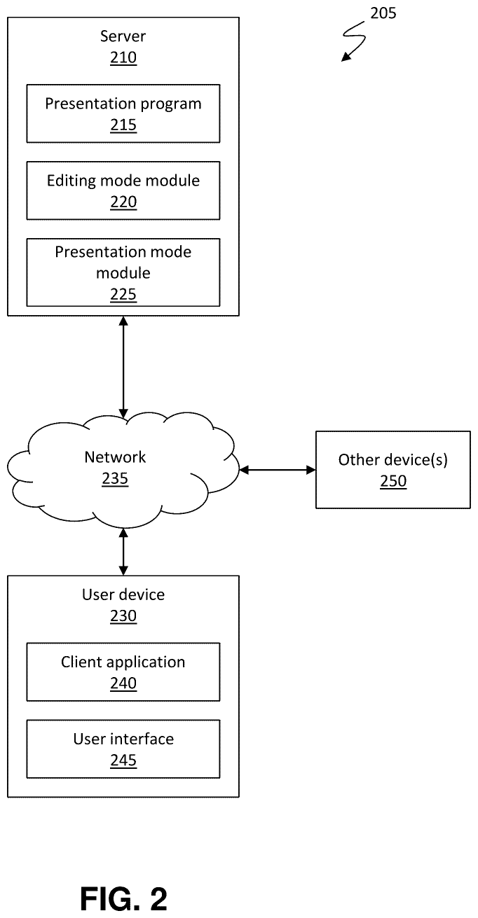

FIG. 2 shows a block diagram of an exemplary environment 205 in accordance with aspects of the invention. In embodiments, the environment 205 includes a server 210 that provides a presentation program 215 as a web service of software-as-a-service (SaaS) to client devices. The server 210 may comprise a computing system such as one or more instances of the computer 101 of FIG. 1, or one or more virtual machines or containers running on one or more instances of the computer 101 of FIG. 1.

In embodiments, the server 210 of FIG. 2 comprises an editing mode module 220 and a presentation mode module 225, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In one example, the editing mode module 220 and the presentation mode module 225 are programmed into the software of the presentation program 215. In another example, the editing mode module 220 and the presentation mode module 225 comprise a software extension or a plugin that adds functionality to the software of the presentation program 215 without changing the software of the presentation program 215. Other implementations may be used by which the functionality of the editing mode module 220 and the presentation mode module 225 is provided to the presentation program 215.

In accordance with aspects of the invention, and with continued reference to FIG. 2, the environment 205 includes a user device 230 that communicates with the server 210 via a network 235. The user device 230 may comprise one or more instances of the EUD 103 of FIG. 1, and the network 235 may comprise one or more networks including, for example, the WAN 102 of FIG. 1. In embodiments, the user device 230 includes a client application 240 which is software that is configured to communicate with the presentation program 215 in a manner that permits a user of the user device 230 to utilize the presentation program 215 in a user interface 245 displayed by the user device 230. In various examples, the client application 240 may comprise software that is specifically programmed for the presentation program 215 or may comprise a browser that provides web-based access to the presentation program 215.

The presentation program 215 is software that permits a user to create and present a digital presentation (referred to herein simply as a presentation). In an editing mode, a user may use the presentation program 215 (e.g., via the user interface 245 of the client application 240) to create a new presentation document or edit an existing presentation document by performing editing actions including, but not limited to, adding new slides, deleting existing slides, adding content to slides, editing content in slides, and arranging an order of the slides. These editing actions and other editing actions are understood in the art of computer-based presentation programs. The presentation program 215 saves the presentation document which is a computer file that includes data that defines the content of the digital presentation.

Still referring to the presentation program 215, in a presentation mode a user may use the presentation program 215 (e.g., via the user interface 245 of the client application 240) to present a presentation on the user device 230 and/or one or more other devices 250. The one or more other devices 250 may include other computing devices such as laptop computers, desktop computer, tablet computers, smartphones, etc. The one or more other devices 250 may additionally or alternatively include video projectors, televisions, etc. Presenting the presentation may include opening the presentation document and causing the user device 230 and/or the one or more other devices 250 to present the presentation defined in the presentation document, e.g., by displaying video content of the presentation (e.g., via a video display or video projector) and optionally emitting audio content of the presentation (e.g., via an audio speaker). For example, presenting the presentation may comprise displaying slides of the presentation in a prescribed order with automatic or manual advancement from one slide to the next.

With continued reference to FIG. 2, and in accordance with aspects of the invention, the editing mode module 220 is configured to permit a user to define time control configuration settings associated with a presentation while a user is editing the presentation document via the user interface 245 of the client application 240. In embodiments, the time control configuration settings include one or more of: a total time duration of the presentation; a respective time allocated for each respective one of the slides of the presentation; a flag to mark each respective one of the slides of the presentation as mandatory or optional; a respective priority ranking associated with each respective one of the slides of the presentation; and an indicator visibility setting associated with the presentation. In embodiments, the editing mode module 220 causes the user interface 245 (e.g., via the presentation program 215 and the client application 240) to display one or more input fields associated with the time control configuration settings, so that a user may provide user input via the user interface 245 to define values of the time control configuration settings. In embodiments, the editing mode module 220 embeds metadata in the presentation document based on such user input, where the metadata defines the time control configuration settings associated with this presentation.

In accordance with aspects of the invention, the presentation mode module 225 is configured to automatically and dynamically adapt content of the presentation while the user is presenting the presentation, e.g., on the user device 230 and/or the one or more other devices 250. In embodiments, the presentation mode module 225 reads the time control configuration settings from the presentation document of the presentation and automatically and dynamically adapts content of the presentation based on these settings while the user is presenting the presentation. In one example, the adapting content of the presentation includes skipping one or more slides of the presentation based on a time remaining for the presentation (e.g., based on the total time duration of the presentation minus a run time of the presentation that has already occurred) being less than a sum of times of slides remaining in the presentation. In this example, the presentation mode module 225 determines which one or more slides to skip based on the mandatory/optional status of each of the remaining slides and/or the priority ranking of each of the remaining slides. In another example, the adapting the presentation includes adding back in one or more slides that were previously marked for skipping based on the time remaining for the presentation (e.g., based on the total time duration of the presentation minus a run time of the presentation that has already occurred) being greater than a sum of times of slides remaining in the presentation.

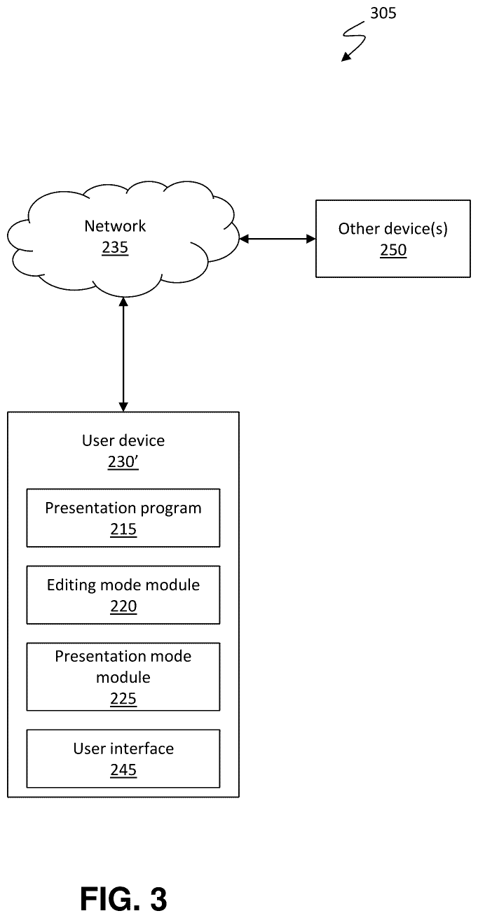

FIG. 2 as described thus far shows an embodiment in which the presentation program 215, the editing mode module 220, and the presentation mode module 225 reside on the server 210. FIG. 3 shows an embodiment including an environment 305 in which the presentation program 215, the editing mode module 220, and the presentation mode module 225 reside locally on the user device 230′. The functionality of the presentation program 215, the editing mode module 220, and the presentation mode module 225 are the same in the embodiment of FIG. 3 as in the embodiment of FIG. 2. For example, in both embodiments, the user may utilize the user interface 245 to edit a presentation in an editing mode and to present the presentation in a presenting mode. Also, in both embodiments, the editing mode module 220 is configured to permit the user to define the time control configuration settings associated with this presentation and save the settings in the presentation document, and the presentation mode module 225 is configured to automatically and dynamically adapt the presentation based on these settings while the user is presenting the presentation.

In some implementations, the presentation mode module 225 is part of, or a plug in or an extension of, a web conference application running on the server 210 or another server that is remote from the user device 230/230′. In these implementations, the presentation program 215 and the editing mode module 220 may be on the server 210 or the user device 230/230′. In this manner, the operations of at least the presentation mode module 225 may be performed as part of a web conference service, e.g., while the presentation is being presented as part of a web conference.

In some implementations, the editing mode module 220 includes or accesses an artificial intelligence (AI) model that causes the editing mode module 220 to suggest values for the time control configuration settings associated with a presentation and saved in a presentation document 405. In these implementations, the editing mode module 220 uses the AI model to analyze the content of the presentation and to suggest values for the time control configuration settings for the presentation based on this analysis. The AI model may be trained using historic (e.g., previous) presentations created by this user and/or historic presentations created by other users. The training may be based on parameters such as, but not limited to, the number of slides in the historic presentations, the content of the slides in the historic presentations, and the time control configuration settings associated with the historic presentations. In this manner, the AI model may be trained to analyze similar parameters of a current presentation and make suggestions for the time control configuration settings based on that analysis. In even further embodiments, the human user may accept, reject, or modify the time control configuration settings that are suggested by the editing mode module 220. For example, as the user is creating/editing the presentation via the user interface 245, the editing mode module 220 may make suggestions for one or more of the time control configuration settings, where the suggestions are visible to the user in the user interface 245. In this example, the user can provide input via the user interface 245 to accept, reject, or modify the time control configuration settings that are suggested by the editing mode module 220.

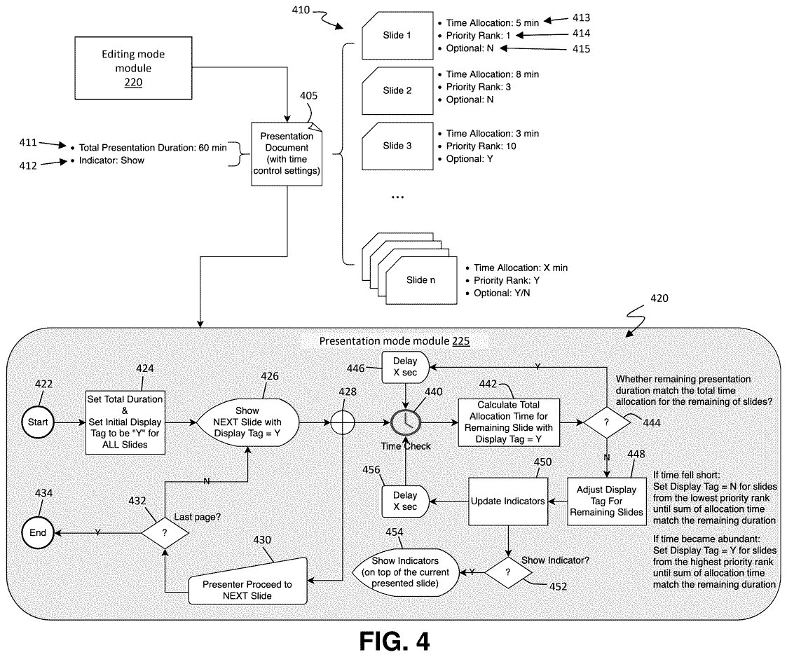

FIG. 4 shows an exemplary workflow diagram that illustrates aspects of the present invention. Operations associated with the diagram may be carried out in the environment of FIG. 2 or FIG. 3 and are described with reference to elements depicted in FIG. 2 and FIG. 3.

In the diagram of FIG. 4, in response to user input via the user interface 245, the editing mode module 220 embeds metadata defining time control configuration settings in a presentation document 405. The presentation document 405 defines a presentation created by a user (e.g., by utilizing the presentation program 215 via the user interface 245), with the presentation including “n” number of slides 410 (Slide 1, Slide 2, Slide 3, . . . , Slide n). The time control configuration settings defined by the user and added to the presentation document 405 include: a total presentation duration 411; an indicator visibility 412; a time allocation 413 for each slide, a priority rank 414 for each slide; and an optional indicator 415 for each slide.

In embodiments, the total presentation duration 411 is a target time for presenting the entire presentation. In this example, the user has provided input that defines the total presentation duration 411 as 60 minutes.

In embodiments, the indicator visibility 412 is a setting that controls whether the presentation program 215 will display one or more indicators to the user while the user is presenting the presentation. In this example, the user has provided input that defines this setting as “show” meaning that the presentation program 215 will display the one or more indicators to the user while the user is presenting the presentation. In other examples, the setting may be defined as “do not show” meaning that the presentation program 215 will not display the one or more predefined indicators to the user while the user is presenting the presentation. The values of “show” and “do not show” are examples, and the system may be configured to utilize other values for this setting.

In embodiments, the time allocation 413 for an individual slide is a target time for presenting the individual slide during the presentation. In this example, the user has defined the time allocation as 5 minutes for Slide 1, 8 minutes for Slide 2, and 3 minutes for Slide 3. As is evident from this example, the user may define different respective time allocations for different respective ones of the slides. Although not shown, the user may also define two or more slides as having the same value for the time allocation.

In embodiments, the priority rank 414 for an individual slide is a relative ranking of importance of the slide on a predefined scale. In one example, a lower value of priority rank indicates a higher relative priority, and a higher value of priority rank indicates a lower relative priority. In this example, the user has defined the priority rank as 1 for Slide 1, 3 for Slide 2, and 10 for Slide 3, meaning that Slide 1 has a higher priority than Slide 2, and that Slide 2 has a higher priority than Slide 3. As is evident from this example, the user may define different respective priority ranks for different respective ones of the slides. Although not shown, the user may also define two or more slides as having the same value for the priority rank.

In embodiments, the optional indicator 415 for an individual slide is an indicator of whether this particular slide is mandatory or optional. The user may wish to designate some slides as mandatory for the presentation while designating other slides as optional. In this example, the user has defined Slide 1 as mandatory, Slide 2 as mandatory, and Slide 3 as optional.

With continued reference to FIG. 4, in embodiments the presentation mode module 225 is configured to perform the method 420 using the presentation document 405 that includes the time control configuration settings added by the editing mode module 220. The user starts presenting the presentation at step 422, for example, by activating the presentation mode of the presentation program 215. At step 424 the presentation mode module 225 starts a clock from zero and counting up that keeps track of a run time of the presentation. At step 424 the presentation mode module 225 also tags each slide (e.g., Slides 1-n) with a respective display tag that initially equals “Y”. In embodiments, the display tag for an individual slide is an additional tag that the presentation mode module 225 uses to control whether the individual slide will be shown or skipped during the presentation.

At step 426 the presentation mode module 225 displays the next slide that has a display tag that equals “Y”. In embodiments, the next slide is based on the sequential order of the numbering of the slides, i.e., the slides numbered 1, 2, 3, . . . , n. When the presentation is begun, the next slide is Slide 1 and its display tag is “Y” as was set at step 424. Therefore, at the beginning of the presentation, step 426 comprises displaying Slide 1.

Step 428 represents time the user (e.g., who is also the presenter) spends presenting the current slide, e.g., the slide that was displayed at step 426. The user may spend any amount of time on the current slide. In this example, Slide 1 has a time allocation of 5 minutes. The user may spend this amount of time displaying Slide 1, or may spend more or less time displaying Slide 1. If the user stays on a particular slide for longer than the time allocation associated with that slide, then the presentation mode module 225 may dynamically adapt the presentation by changing the display tag of a subsequent slide from “Y” to “N” as described below.

At step 430 the user provides input to proceed to the next slide. This input may be something such as clicking a mouse or pressing a predefined key on a keyboard, as is understood in the art for advancing a slide during a presentation.

At step 432 the presentation mode module 225 determines whether the slide that was displayed at step 426 is the last slide in the presentation. If the slide that was displayed at step 426 is the last slide in the presentation, then the presentation ends at step 434. If the slide that was displayed at step 426 is not the last slide in the presentation, then the method returns to step 426 where the presentation mode module 225 identifies the next slide in the sequence of slides that has a display tag value of “Y”.

Step 440 represents initiation of a time check that the presentation mode module 225 performs periodically during the presentation. Following initiation of the time check at step 440, at step 442 the presentation mode module 225 calculates the total allocation time for remaining slides that have a display tag of “Y”. In embodiments, the total allocation time for remaining slides equals the sum of the respective time allocation 413 for all slides that (i) have not yet been displayed at step 426 and (ii) have a display tag of “Y”.

At step 444 the presentation module 225 determines whether a remaining presentation time equals the total allocation time for remaining slides (from step 442). In embodiments, the remaining presentation time equals the total presentation duration 411 minus the run time of the presentation (determined from the clock that was started at step 424). At step 444, if the remaining presentation time equals the total allocation time for remaining slides, then this means that the presenter is on pace such that the presenter has sufficient time to show all the remaining slides that have a display tag of “Y” within the total presentation duration. In this case, the presentation module 225 proceeds to step 446 without changing the display tag associated with any of the remaining slides. At step 446 the presentation mode module 225 waits for a predefined delay of “X” seconds before initiating the time check again at step 440.

At step 444, if the remaining presentation time does not equal the total allocation time for remaining slides, then this means that the presenter is either behind pace or ahead of pace for showing the remaining slides that have display tag “Y” in the remaining presentation time. At step 448 the presentation mode module 225 may adjust the display tag of at least one of the remaining slides based on the determination at step 444.

In one example, if the remaining presentation time is less than the total allocation time for remaining slides at step 444, then at step 448 the presentation mode module 225 changes the display tag of one of the remaining slides from “Y” to “N”. In this example, the presenter is behind pace for showing the remaining slides that have display tag “Y” in the remaining presentation time. As a result, the presentation mode module 225 automatically selects one or more of the remaining slides that currently has a display tag of “Y” and changes that display tag to “N”. By changing the display tag of a slide to “N”, this will cause this slide to be skipped when this slide comes up as the next slide at step 426. This is because step 426 involves showing a next slide that has a display tag of “Y”. Moreover, by changing the display tag of a slide to “N”, this will cause this slide's time allocation to be omitted from the total allocation time for remaining slides that is determined at subsequent iterations of step 442. This is because the total allocation time for remaining slides determined at step 442 is the sum of the respective allocation times for all slides that have not yet been displayed and that have a display tag of “Y”, meaning that a slide with a display tag of “N” is not included in this sum. In this manner, when the presentation mode module 225 determines that the presenter is behind pace for showing the remaining slides that have display tag “Y” in the remaining presentation time, the presentation mode module 225 selects one or more of these remaining slides to be skipped, to help the presenter get back on pace.

In embodiments, the presentation mode module 225 determines the one or more slides to change the display tag from “Y” to “N” based on the respective priority rank (e.g., 414) and/or the respective optional indicator (e.g., 415) tag for each of the respective remaining slides. In embodiments, the presentation mode module 225 first determines whether any of the remaining slides are marked as optional (e.g., optional indicator equals “Y”). If any of the remaining slides with display tag “Y” are marked as optional, then the presenting module starts 225 with the lowest priority one or more of these slides and identifies a number of these slides with a collective time allocation that equals or exceeds the difference between the remaining presentation time and the total allocation time for remaining slides. For example, if the difference between the remaining presentation time and the total allocation time for remaining slides (from step 444) is 7 minutes, then the presentation mode module 225 identifies the one or more lowest priority and optional remaining slides whose display tag is “Y” and whose respective time allocations add up to 7 minutes or more. In this example, this would comprise only one remaining slide if the lowest priority and optional remaining slide whose display tag is “Y” has a time allocation that equals or exceeds 7 minutes. In this example, this would comprise more than one remaining slide if the lowest priority and optional remaining slide whose display tag is “Y” has a time allocation that is less than 7 minutes. In embodiments, if the sum of the time allocations of the remaining optional slides whose display tag is “Y” is less than the difference between the remaining presentation time and the total allocation time for remaining slides (from step 444), then the presentation mode module 225 may additionally identify one or more of the lowest priority mandatory slides to change the display tag from “Y” to “N”. In this manner, the presentation mode module 225 selects a number of remaining slides that have a display tag of “Y”, the selecting being based first on lowest priority optional slides to highest priority optional slides, the selecting being based thereafter on lowest priority mandatory slides to highest priority mandatory slides, and the selecting being performed until the sum of time allocations of all the slides selected (e.g., all the slides being changed from display tag “Y” to “N”) equals or exceeds the difference between the remaining presentation time and the total allocation time for remaining slides.

With continued reference to step 448, in another example, if the remaining presentation time is greater than the total allocation time for remaining slides at step 444, then at step 448 the presentation mode module 225 changes the display tag of one of the remaining slides from “N” to “Y”. In this example, the presenter is ahead of pace for showing the remaining slides that have display tag “Y” in the remaining presentation time. As a result, the presentation mode module 225 automatically selects one or more of the remaining slides that currently has a display tag of “N” and changes that display tag to “Y”. By changing the display tag of a slide to “Y”, this will cause this slide to be shown when this slide comes up as the next slide at step 426. Moreover, by changing the display tag of a slide to “Y”, this will cause this slide's time allocation to be included in from the total allocation time for remaining slides that is determined at subsequent iterations of step 442. In this manner, when the presentation mode module 225 determines that the presenter is ahead of pace for showing the remaining slides that have display tag “Y” in the remaining presentation time, the presentation mode module 225 selects one or more slides that are currently tagged to be skipped (e.g., display tag “N”) and brings these one or more slides back into the presentation (e.g., display tag “Y”). The order for selecting the one or more slides to change the display tag from “N” to “Y” may be the reverse of the order that was described for selecting the slides to change the display tag from “Y” to “N”.

At step 450 the presentation mode module 225 updates one or more indicators based on the adjusting that was performed at step 448. In embodiments, the indicators comprise one or more visual indicators that are displayed to the presenter during the presentation, where the indicators notify the presenter than the presentation has been adapted by either dropping one or more slides based on being behind pace or adding one or more slides based on being ahead of pace. An indicator may comprise text or a graphic that is displayed only to the presenter during the presentation. An indicator may include one or more of the following types of information:
the presentation is behind pace; an amount of time the presentation is behind pace; an indication of how many slides have been dropped (e.g., display tag changed to “N”); an indication of how many of the dropped slides (e.g., display tag changed to “N”) are optional (e.g., optional indicator “Y”); and an indication of how many of the dropped slides (e.g., display tag changed to “N”) are mandatory (e.g., optional indicator “N”). These types of information are examples, and other types of information may be included in an indicator. In embodiments, a dropped slide is a slide that is marked for being skipped (e.g., display tag changed to “N”) but that has not yet been skipped in the presentation, where a skipped slide refers to a slide that has been marked for being skipped and has been skipped at step 426. At step 450, for whichever one or more types of information is included in the indicator, the presentation mode module 225 updates the information based on the adjustments that were made at step 448.

At step 452, the presentation mode module 225 determines whether to show the indicator. In embodiments, if the indicator visibility 412 setting is “Show” then at step 454 the presentation mode module 225 displays the indicator (from step 450) to the presenter, e.g., in the presenter's view of the presentation. In embodiments, if the indicator visibility 412 setting is “Do not show” then at step 454 the presentation mode module 225 does not display the indicator (from step 450) to the presenter.

At step 456 the presentation mode module 225 waits for a predefined delay of “X” seconds before initiating the time check again at step 440. In accordance with aspects of the invention, the presentation mode module 225 automatically initiates the time check at step 440 and the subsequent steps on a periodic basis, in the background while the presenter is presenting the presentation at steps 428 and 430. In this manner, the presentation mode module 225 is configured to automatically and dynamically update the presentation by dropping slides (e.g., changing their display tag from “Y” to “N”) when the presenter is behind pace for the presentation, and alternatively by adding dropped slides back in (e.g., changing their display tag from “N” to “Y”) when the presenter is ahead of pace for the presentation.

As is evident from FIG. 4, implementations of the invention provide for time checking and automatic adaptation. In embodiments, once the presentation mode starts, the presentation mode module 225 employs a time check algorithm (e.g., beginning at step 440) to track the progress of the presentation against the total presentation duration. As the presentation unfolds, the presentation mode module 225 estimates whether the remaining time will be insufficient to cover all slides adequately.

As is evident from FIG. 4, implementations of the invention provide for automatic slide selection. In embodiments, in response to time constraints, the presentation mode module 225 internally selects and marks optional slides to be skipped (e.g., changes the display tag to “N”) in order to accommodate the available time. The selection process may be based on the priority ranking assigned by the presenter (e.g., the priority rank 414 of each slide). Less important slides may be chosen to be skipped over those ranked with higher priority. Among the optional slides with the same priority ranking, the estimated time required for each slide and their position in the presentation may also be considered.

As is evident from FIG. 4, implementations of the invention provide for seamless presentation flow. In embodiments, as the presenter proceeds with their delivery, the presentation mode module 225 automatically skips the marked-skip slides (e.g., slides with display tag “N”) at step 426 as if they do not exist. This ensures a smoother flow for the presenter, and the audience remains unaware that certain content has been skipped. The presentation continues without interruptions that would be noticed if performed manually.

In some embodiments, the system ranks remaining slides of the presentation using machine learning based on past presentations and manual inputs. For example, if the user has not provided priority rankings to one or more slides in a presentation, the system may automatically assign a priority rank to these slides using a machine leaning model. The machine learning model may be trained using training data comprising past (e.g., historic) presentations by this user and how the user ranked similar slides in those past presentations.

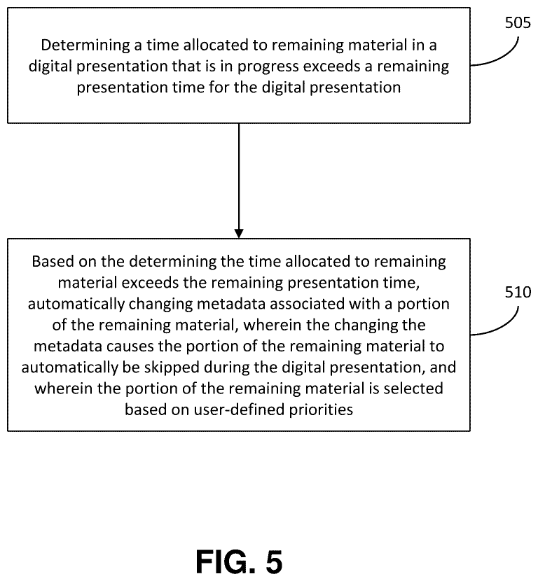

FIG. 5 shows a flowchart of an exemplary method in accordance with aspects of the present invention. Steps of the method (also called operations) may be carried out in the environment of FIG. 2 or FIG. 3 and are described with reference to elements depicted in FIG. 2 and FIG. 3 and operations described in FIG. 4.

At step 505 the system determines that the time allocated to remaining material in a digital presentation that is in progress exceeds the remaining presentation time for the digital presentation. In embodiments, and as described with respect to steps 442 and 444 of FIG. 4, the presentation mode module 225 determines a total allocation time for remaining slides that have a display tag of “Y”, and the presentation mode module 225 determines whether a remaining presentation time equals, is greater than, or is less than the total allocation time for remaining slides.

At step 510, based on the determining the time allocated to remaining material exceeds the remaining presentation time, the system automatically changes metadata associated with a portion of the remaining material. In embodiments, and as described with respect to steps 444 and 448 of FIG. 4, the presentation mode module 225 changes the display tag of one or more of the remaining slides from “Y” to “N”. In accordance with aspects of the invention, changing the display tag of a particular slide from “Y” to “N” will cause this slide to be skipped when this slide comes up as the next slide at step 426. In embodiments, and as described with respect to step 448 of FIG. 4, the presentation mode module 225 selects the one or more of the remaining slides for which to change the display tag from “Y” to “N” based on the user-defined priorities including priority rank and/or optional indicator associated with each slide.

In embodiments of the method, the digital presentation comprises slides (e.g., Slides 1-n of FIG. 4) and the user-defined priorities comprise respective priority ranks associated with respective ones of the slides (e.g., priority rank 414).

In embodiments of the method, the user-defined priorities further comprise respective optional indicators associated with the respective ones of the slides (e.g., optional indicator 415).

In embodiments of the method, the remaining material comprises a subset of the slides that have not yet been displayed during digital presentation.

In embodiments of the method, the changing the metadata comprises changing a respective display tag associated with a respective slide in the subset.

In embodiments of the method, the user-defined priorities are defined by user input prior to the digital presentation being in progress and saved in a presentation document.

In embodiments, the method further comprising displaying an indicator to a presenter that is presenting the digital presentation while the digital presentation is in progress, wherein the indicator includes information that is based on the changing the metadata.

In embodiments of the method, the time allocated to remaining material and the remaining presentation time are determined at a first time while the digital presentation is in progress, and the method further comprises: determining, at a second time while the digital presentation is in progress, a second time allocated to remaining material in the digital presentation is less than a second remaining presentation time for the digital presentation; and based on the determining the second time allocated to remaining material is less than the second remaining presentation time, automatically changing second metadata associated with a second portion of the digital presentation, wherein the changing the second metadata causes the second portion of the digital presentation to not be skipped during the digital presentation.

It is thus understood from the foregoing description that implementations of the invention may be used to provide a system and method for dynamically adjusting a digital presentation comprising: determining, while a presentation is in progress, an amount of time scheduled to give the presentation and an amount of material remaining in the presentation; determining, at time to present the amount of material remaining exceeds the scheduled time; ranking, by machine learning based on past presentations and manual inputs, portions of the remaining presentations; dynamically altering by removing slides and/or removing content from the remaining presentation to fit in the remaining time, wherein the lowest ranked material is removed and/or the highest ranked material is maintained; and continuously monitoring the time remaining versus the content remaining after adjustment while continuing to update the slides. The method may include the estimation of time for individual slides and the identification of specific slides as optional, with each assigned priority ratings during the preparation of presentation documents. This facilitates tailored content display rooted in significance and flexibility, all within prescribed time limits. The method may include optimizing presentation delivery, whereby presenters define a comprehensive time limit before initiation, thus enabling precise control over the exact duration aimed for in the presentation. The method may include involving the automatic selection of optional slides for exclusion based on priority rankings and estimated time. This ensures the preservation of essential content coverage within stipulated time confines. Through the seamless omission of marked optional slides, it guarantees a fluid presenter performance and a continuous experience for the audience. The method may include, for material omitted earlier in the presentation, if subsequent time checks indicate a surplus of available time, selectively reintroducing them to the dynamic presentation flow based on their estimated time and priority rankings.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining a time allocated to remaining material in a digital presentation that is in progress exceeds a remaining presentation time for the digital presentation; and
based on the determining the time allocated to the remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

2. The computer-implemented method of claim 1, wherein:
the digital presentation comprises slides; and
the user-defined priorities comprise respective priority ranks associated with respective ones of the slides.

3. The computer-implemented method of claim 2, wherein the user-defined priorities further comprise respective optional indicators associated with the respective ones of the slides.

4. The computer-implemented method of claim 2, wherein the remaining material comprises a subset of the slides that have not yet been displayed during the digital presentation.

5. The computer-implemented method of claim 4, wherein the changing the metadata comprises changing a respective display tag associated with a respective slide in the subset.

6. The computer-implemented method of claim 1, wherein the user-defined priorities are defined by user input and saved in a presentation document prior to the digital presentation being in progress.

7. The computer-implemented method of claim 1, wherein the user-defined priorities are suggested by an artificial intelligence model and saved in a presentation document prior to the digital presentation being in progress.

8. The computer-implemented method of claim 1, wherein the changing the metadata is performed while the digital presentation is being presented in a web conference.

9. The computer-implemented method of claim 1, further comprising displaying an indicator to a presenter that is presenting the digital presentation while the digital presentation is in progress, wherein the indicator includes information that is based on the changing the metadata.

10. The computer-implemented method of claim 1, wherein the time allocated to remaining material and the remaining presentation time are determined at a first time while the digital presentation is in progress, and further comprising:
determining, at a second time while the digital presentation is in progress, a second time allocated to remaining material in the digital presentation is less than a second remaining presentation time for the digital presentation; and
based on the determining the second time allocated to remaining material is less than the second remaining presentation time, automatically changing second metadata associated with a second portion of the digital presentation, wherein the changing the second metadata causes the second portion of the digital presentation to not be skipped during the digital presentation.

11. A computer program product comprising:
one or more computer-readable storage media; and
program instructions stored on the one or more computer-readable storage media to perform operations comprising:
determining a time allocated to remaining material in a digital presentation that is in progress exceeds a remaining presentation time for the digital presentation; and
based on the determining the time allocated to the remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

12. The computer program product of claim 11, wherein:
the digital presentation comprises slides; and
the user-defined priorities comprise respective priority ranks associated with respective ones of the slides.

13. The computer program product of claim 12, wherein the user-defined priorities further comprise respective optional indicators associated with the respective ones of the slides.

14. The computer program product of claim 12, wherein the remaining material comprises a subset of the slides that have not yet been displayed during digital presentation.

15. The computer program product of claim 11, wherein the operations further comprise displaying an indicator to a presenter that is presenting the digital presentation while the digital presentation is in progress, wherein the indicator includes information that is based on the changing the metadata.

16. The computer program product of claim 11, wherein the time allocated to the remaining material and the remaining presentation time are determined at a first time while the digital presentation is in progress, and wherein the operations further comprise:
determining, at a second time while the digital presentation is in progress, a second time allocated to remaining material in the digital presentation is less than a second remaining presentation time for the digital presentation; and
based on the determining the second time allocated to remaining material is less than the second remaining presentation time, automatically changing second metadata associated with a second portion of the digital presentation, wherein the changing the second metadata causes the second portion of the digital presentation to not be skipped during the digital presentation.

17. A computer system comprising:
a processor set;
one or more computer-readable storage media; and
program instructions stored on the one or more computer-readable storage media to cause the processor set to perform operations comprising:
determining a time allocated to remaining material in a digital presentation that is in progress exceeds a remaining presentation time for the digital presentation; and
based on the determining the time allocated to the remaining material exceeds the remaining presentation time, automatically changing metadata associated with a portion of the remaining material, wherein the changing the metadata causes the portion of the remaining material to automatically be skipped during the digital presentation, and wherein the portion of the remaining material is selected based on user-defined priorities.

18. The computer system of claim 17, wherein:
the digital presentation comprises slides; and
the user-defined priorities comprise respective priority ranks associated with respective ones of the slides.

19. The computer system of claim 17, further comprising displaying an indicator to a presenter that is presenting the digital presentation while the digital presentation is in progress, wherein the indicator includes information that is based on the changing the metadata.

20. The computer system of claim 17, wherein the time allocated to the remaining material and the remaining presentation time are determined at a first time while the digital presentation is in progress, and wherein the operations further comprise:
determining, at a second time while the digital presentation is in progress, a second time allocated to remaining material in the digital presentation is less than a second remaining presentation time for the digital presentation; and
based on the determining the second time allocated to remaining material is less than the second remaining presentation time, automatically changing second metadata associated with a second portion of the digital presentation, wherein the changing the second metadata causes the second portion of the digital presentation to not be skipped during the digital presentation.
